(19) United States
(12) Patent Application Publication
(10) Pub. No.: US 2007/0116473 A1
(43) Pub. Date: May 24, 2007

(54) System and method for transmitting data

(75) Inventor: Ying-Tai Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/601,907

(22) Filed: Nov. 20, 2006

(30) Foreign Application Priority Data
Nov. 18, 2005 (TW) 94140624

(51) Int. Cl. H04B 10/00

(52) U.S. Cl. 398/140

(57) ABSTRACT

An exemplary data transmission system for preventing noise includes a transmitter and a receiver. The transmitter includes two pins, and first pin is used for providing data and second pin is used for providing select/enable signals. The receiver includes two pins, and first pin is used for receiving data from first pin of the transmitter and the second pin is connected to second pin of the transmitter. The transmitter and the receiver each include a third pin. The third pin of the receiver is used for providing feedback signal to the third pin of the transmitter. The data transmission system can check if the receiving data is right or wrong. When receiving signal is wrong, the transmitter can resend the right data again. A related method for transmitting data is also provided.

### BACKGROUND OF THE INVENTION

1. Field of the Invention

The invention relates to a data transmission system, and particularly an interference-free data transmission system and a method for using the system.

2. General Background

A data transmission device such as a computer or a portable electronic device may be subject to interference, such as by Electrostatic Discharge (ESD). Also, data transmission performed by the data transmission device may be interfered with by noise. In either of these cases, a malfunction during the data transmission process is liable to occur. When this happens, the data transmission device itself may malfunction.

For example, a personal computer (PC) system is a well known data transmission system. In a conventional PC, a Northbridge chip and an I/O chip are both located on a motherboard and electrically connected through wires. The wires typically provide functions such as a data bus, an address bus, and a control bus. The Northbridge chip (which can be considered as a “receiver”) is the central controlling unit, and receives signals which are to be processed. The I/O chip (which can be considered as a “transmitter”) receives signals from input/output peripheral devices (such as a printer, a mouse, a keypad, etc.), and transmits the signals to the Northbridge chip.

Referring to FIG. 7, this is a schematic diagram of a conventional data transmission system within a PC system. The data transmission system 100 includes a data transmitter 18 and a data receiver 19. The data transmitter 18 has at least two pins, designated as pin 1 and pin 2. Pin 1 is set as a data input/output port for providing 8-bit data signals, and pin 2 is set as an output control port for providing output control signals (select/enable). The data receiver 19 has at least two pins, designated as pin 3 and pin 4. Pin 3 is set as a data input/output port for receiving data signals from pin 1 of the data transmitter 18. Pin 4 is set as an input port for receiving control signals from pin 2 of the data transmitter 18.

Also referring to FIG. 8, this is a timing diagram of transmission of data from the data transmitter 18 to the data receiver 19. During a period T1-T2, pin 2 of the data transmitter 18 is set as enable (“high”, also known as “1”). At the same time, the data transmitter 18 transmits 8-bit data from pin 1 thereof to pin 3 of the data receiver 19. In the illustration, the 8-bit data is 11010001, and is transmitted from LSB (Least Significant Bit) to MSB (Most Significant Bit).

When an ESD or interference by noise occurs during data transmission, a transmission error of at least one bit may result. For example, the data receiver 19 may receive a wrong data signal such as 10010001 instead of receiving the correct data signal 11010001. A typical consequence of such error is that the data receiver 19 receives a wrong instruction and malfunctions. This may occur, for example, during a data storage process, a data retrieval process, etc. Commonly, a final outcome is that the PC system crashes.

### SUMMARY

In one aspect, a data transmission system includes a transmitter and a receiver. The transmitter has at least a first pin and a second pin. The first pin is configured for providing data signals, and the second pin is configured for providing control signals (e.g. select/enable). The receiver has at least a first pin and a second pin. The first pin is configured for receiving data signals from the first pin of the transmitter, and the second pin is configured for receiving control signals from the second pin of the transmitter. The transmitter and the receiver each have a third pin. The third pin of the receiver is configured for providing a feedback signal to the third pin of the transmitter.

In another aspect, a data transmission system includes a transmitter and a receiver. The transmitter has at least a first pin and a second pin. The first pin is configured for providing data signals, and second pin is configured for providing control signals. The receiver has at least a first pin and a second pin. The first pin is configured for receiving data signals from the first pin of the transmitter, and the second pin is configured for receiving control signals from the second pin of the transmitter. The transmitter and the receiver each have a third pin and a fourth pin. The third pin of the transmitter is for providing check signals to the third pin of the receiver, and the fourth pin of the transmitter is used for receiving a feedback signal from the fourth pin of the receiver.

An exemplary data transmission method includes the following steps: (a) providing a data signal during a first time period; (b) providing a check signal in accordance with data signal during a second time period; (c) comparing check signal and data signal; and (d) providing another data signal when check signal and data signal match with each other; otherwise, providing a feedback signal and re-providing data signal until check signal matches data signal.

Advantages and novel features of the above-described systems and method will become more apparent from the following detailed description when taken in conjunction with the accompanying drawings, in which:

### BRIEF DESCRIPTION OF THE DRAWINGS

FIG. 1 is a schematic diagram of a data transmission system according to a first embodiment of the present invention, the system including a transmitter and a receiver;

FIG. 2 is a timing diagram of transmission of a correct data signal from the transmitter to the receiver of FIG. 1;

FIG. 3 is a timing diagram of transmission of a wrong data signal from the transmitter to the receiver of FIG. 1;

FIG. 4 is a schematic diagram of a data transmission system according to a second embodiment of the present invention, the system including a transmitter and a receiver;

FIG. 5 is a timing diagram of transmission of a correct data signal from the transmitter to the receiver of FIG. 4;

FIG. 6 is a timing diagram of transmission of a wrong data signal from the transmitter to the receiver of FIG. 4;

FIG. 7 is a schematic diagram of a conventional data transmission system, the system including a transmitter and a receiver; and

FIG. 8 is a timing diagram of transmission of data from the transmitter to the receiver of FIG. 7.

### DETAILED DESCRIPTION OF PREFERRED EMBODIMENTS

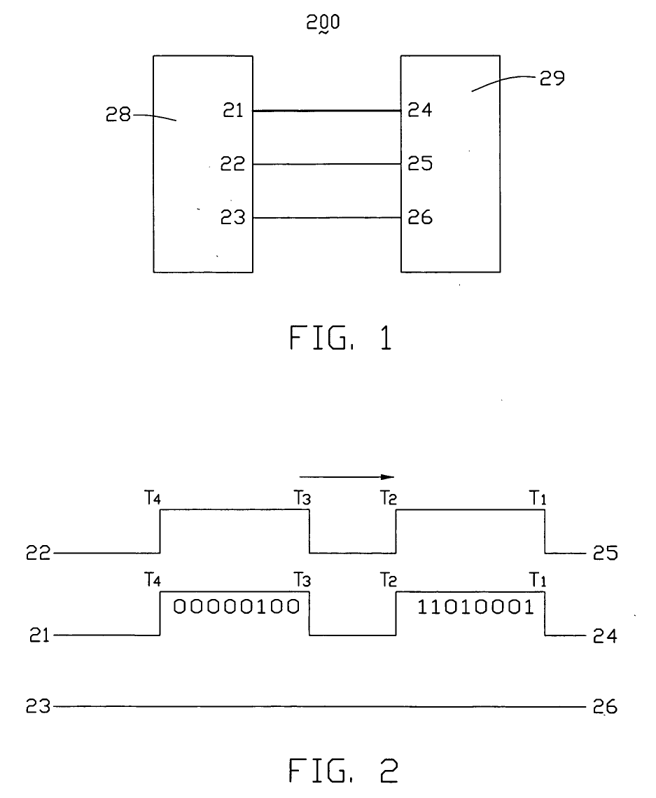

Referring to FIG. 1, this is a schematic diagram of a data transmission system according to a first embodiment of the present invention. The data transmission system 200 is typically utilized in devices such as a PC system or a portable electronic device. The data transmission system 200 includes a transmitter 28 and a receiver 29. In a preferred embodiment, the transmitter 28 includes at least three pins 21, 22, and 23. Pin 21 can be used as a data input/output port so as to transmit 8-bit data signals and check signals. Pin 22 can be used as an output port so as to transmit control signals such as select/enable signals. Pin 23 can be used as an input port so as to receive feedback signals from the receiver 29. The receiver 29 includes at least three pins 24, 25, and 26, corresponding to the pins 21, 22, 23 of the transmitter 28. In the preferred embodiment, pin 24 can be used as a data input/output port so as to receive data signals and check signals from pin 21 of the transmitter 28. Pin 25 can be used as an input port so as to receive control signals from pin 22 of the transmitter 28. Pin 26 can be used as an output port so as to transmit feedback signals to pin 23 of the transmitter 28. It should be noted that when the received signals, such as a data signal and a check signal, do not match with each other (compared by a comparator which is not shown in the drawings), the receiver 29 sends a corresponding feedback signal through pins 26 and 23 to the transmitter 28. Then the transmitter 28 re-sends the original data signal through pins 21 and 24 to the receiver 29.

FIG. 2 is a timing diagram of transmission of a correct data signal from the transmitter 28 to the receiver 29. In time periods T1-T2 and T3-T4, pin 22 of the transmitter 28 is set as “high” (also known as “1”). In the period T1-T2, an 8-bit data signal, 11010001, is provided from the transmitter 28 through pin 21 to the receiver 29 through pin 24. In the preferred embodiment, a check signal is the sum of each bit of a data signal. For example, when the data signal is 11010001 in binary coded form, the corresponding check signal is the sum of each binary bit; namely 1+1+0+1+0+0+0+1=4 (decimal coded). The check signal in binary form is 00000100. In the period T3-T4, the check signal 00000100 is provided from the transmitter 28 through pin 21 to the receiver 29 through pin 24. Thus, the data signal and the check signal match with each other. There is no feedback signal provided from the receiver 29 through pin 26, and pin 23 of the transmitter 28 is set as “low” (also known as “0”). In an alternative mode of operation, the check signal can be provided in the period T1-T2, and the data signal can be provided in the period T3-T4.

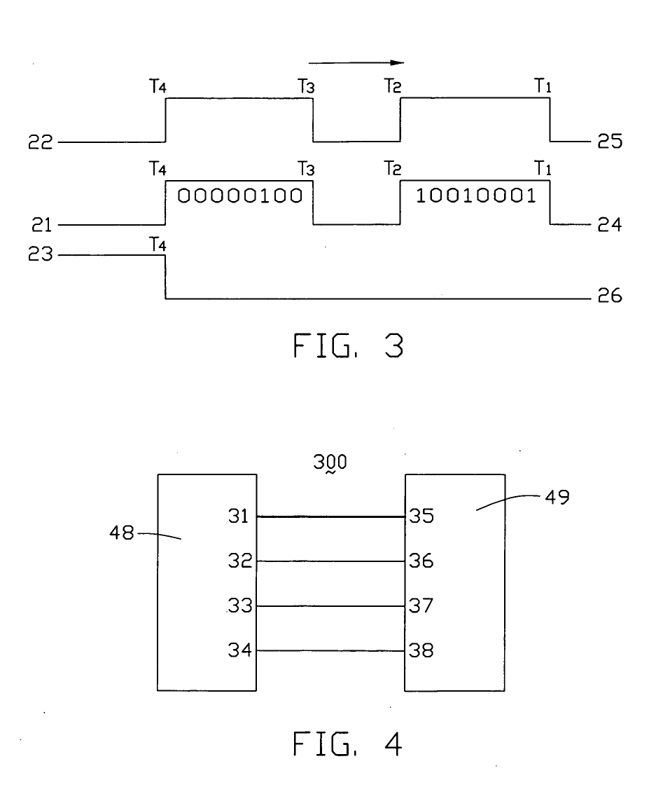

FIG. 3 is a timing diagram of transmission of a wrong data signal from the transmitter 28 to the receiver 29. In time periods T1-T2 and T3-T4, pin 22 of the transmitter 28 is set as “high” (also known as “1”). In the period T1-T2, an 8-bit data signal, 11010001, is provided from the transmitter 28 through pin 21. A check signal is the sum of each bit of a data signal. Thus the corresponding check signal is the sum of each binary bit, namely 1+1+0+1+0+0+0+1=4 (decimal coded). The check signal in binary form is 00000100. In the period T3-T4, the check signal 00000100 is provided from the transmitter 28 through pin 21. As shown in FIG. 3, due to interference, the provided data signal 11010001 is changed into an incorrect data signal 10010001. The corresponding check signal for the incorrect data signal 10010001 would be the sum of each binary bit, namely 1+0+0+1+0+0+0+1=3 (decimal coded). Thus the incorrect data signal 10010001 and the check signal 00000100 actually received by the receiver 29 do not match with each other. Accordingly, a feedback signal is provided from the receiver 29 through pin 26, and pin 23 of the transmitter 28 is set as “high” at time T4. Therefore, the correct data signal 11010001 is re-sent from the transmitter 28 to the receiver 29. In the alternative mode of operation, the check signal can be provided in the period T1-T2, and the data signal can be provided in the period T3-T4.

Referring to FIG. 4, this is a schematic diagram of a data transmission system according to a second embodiment of the present invention. The data transmission system 300 includes a transmitter 48 and a receiver 49. In a preferred embodiment, the transmitter 48 includes at least four pins 31, 32, 33, and 34. Pin 31 can be used as a data input/output port so as to transmit 8-bit data signals. Pin 32 can be used as a first output port so as to transmit 8-bit check signals. Pin 33 can be used as a second output port so as to transmit control signals such as select/enable signals. Pin 34 can be used as an input port so as to receive feedback signals from the receiver 49. The receiver 49 includes at least four pins 35, 36, 37 and 38, corresponding to the pins 31, 32, 33, and 34 of the transmitter 48. In the preferred embodiment, pin 35 can be used as a data input/output port so as to receive the data signals from pin 31 of the transmitter 48. Pin 36 can be used as a first input port so as to receive the check signals from pin 32 of the transmitter 48. Pin 37 can be used as a second input port so as to receive the control signals from pin 33 of the transmitter 48. Pin 38 can be used as an output port so as to transmit feedback signals to pin 34 of the transmitter 48. It should be noted that when the received signals, such as a data signal and a check signal, do not match with each other, the receiver 49 sends a corresponding feedback signal through pins 38 and 34 to the transmitter 48. Then the transmitter 48 re-sends the original data signal through pins 31 and 35 to the receiver 49.

FIG. 5 is a timing diagram of transmission of a correct data signal from the transmitter 48 to the receiver 49. In a time period T1-T2, pin 33 of the transmitter 48 is set as “high” (also known as “1”), and an 8-bit data signal, 11010001, is provided from the transmitter 48 through pin 31 to the receiver 49 through pin 35. In the preferred embodiment, a check signal is the sum of each bit of a data signal. For example, the data signal 11010001 is a binary coded form. The corresponding check signal is the sum of each binary bit, namely 1+1+0+1+0+0+0+1=4 (decimal coded). The check signal in binary form is 00000100. In the period T1-T2, the check signal 00000100 is provided from the transmitter 48 through pin 32 to the receiver 49 through pin 36. Thus, the data signal and the check signal match with each other. There is no feedback signal provided from the receiver 49 through pin 38, and pin 34 of the transmitter 48 is set as “low” (also known as “0”).

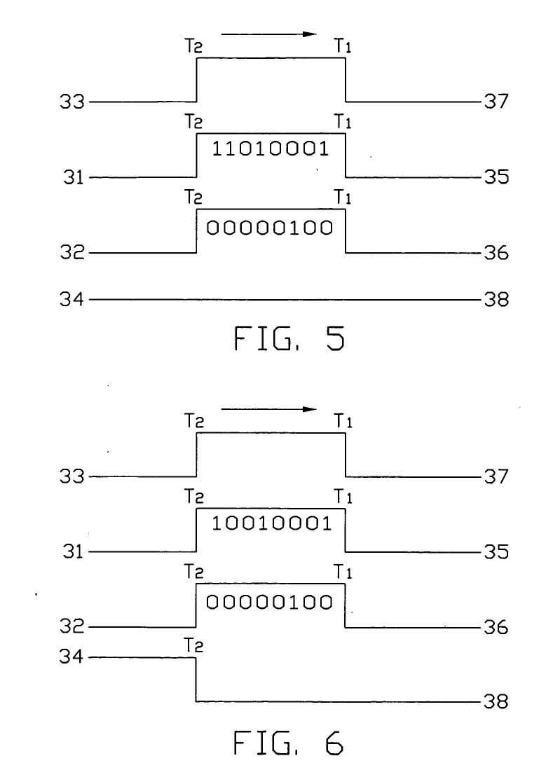

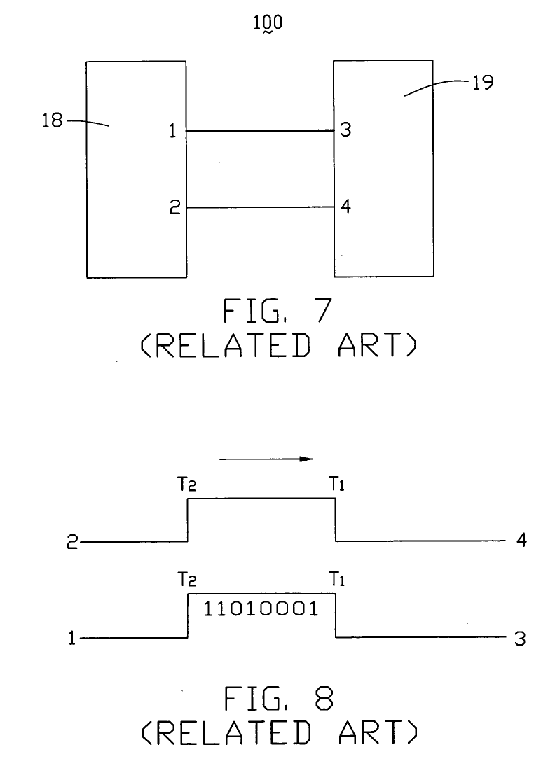

FIG. 6 is a timing diagram of transmission of a wrong data signal from the transmitter 48 to the receiver 49. In a time period T1-T2, pin 33 of the transmitter 48 is set as “high” (also known as “1”), and an 8-bit data signal, 11010001, is provided from the transmitter 48 through pin 31. A check signal is the sum of each bit of a data signal. Thus the corresponding check signal is the sum of each binary bit, namely 1+1+0+1+0+0+0+1=4 (decimal coded). The check signal in binary form is 00000100. In the period T1-T2, the check signal 00000100 is provided from the transmitter 48 through pin 32. As shown in FIG. 6, due to interference, the provided data signal 11010001 is changed into an incorrect data signal 10010001. The corresponding check signal for the incorrect data signal 10010001 would be the sum of each binary bit, namely 1+0+0+1+0+0+0+1=3 (decimal coded). Thus the incorrect data signal 10010001 and the check signal 00000100 actually received by the receiver 49 do not match with each other. Accordingly, a feedback signal is provided from the receiver 49 through pin 38, and pin 34 of the transmitter 48 is set as “high” at time T2. Therefore, the correct data signal 11010001 is re-sent from the transmitter 48 to the receiver 49.

In the above-described preferred embodiments, “high level trigger” means are used for providing the data signals, the feedback signals, and other signals. In alternative embodiments, “low level trigger” means can be used instead. Furthermore, 4-bit signals or 16-bit signals can be used in the above-described embodiments instead of 8-bit signals.

ESD events are apt to occur in devices such as PC systems and portable electronic devices, and cause malfunction or breakdown of the device. Thus the above-described systems and methods are very suitable for application in a start-up routine, a shut down routine, or a mode setting routine of a device. The mode setting routine can, for example, be in relation to an idle mode, a sleep mode, etc. In such kinds of applications, erroneous system operation of the device can be avoided.

As would be understood by a person skilled in the art, the foregoing preferred and exemplary embodiments are provided in order to illustrate principles of the present invention rather than limiting the present invention. The above descriptions are intended to cover various modifications and similar arrangements included within the spirit and scope of the appended claims, which scope should be accorded the broadest interpretation so as to encompass all such modifications and similar structures and methods.

We claim:

1. A data transmission system, comprising:
a transmitter comprising at least one first pin and at least one second pin, said at least one first pin being configured for providing data signals, said at least one second pin being configured for providing control signals; and
a receiver comprising at least one first pin and at least one second pin, said at least one first pin being configured for receiving the data signals from said at least one first pin of said transmitter, and said at least one second pin being configured for receiving the control signals from said at least one second pin of said transmitter;
wherein said transmitter and said receiver each further comprise a third pin, and said third pin of said receiver is configured for providing feedback signals to said third pin of said transmitter.

2. The data transmission system as claimed in claim 1, wherein the control signals comprise a select signal and an enable signal.

3. The data transmission system as claimed in claim 1, wherein said transmitter and said receiver each further comprise a fourth pin, wherein said fourth pin of said transmitter is configured for providing check signals to said fourth pin of said receiver.

4. A data transmission method, comprising:
providing a data signal during a first time period;
providing a check signal in accordance with the data signal during a second time period;
comparing the check signal and the data signal; and
providing another data signal when the check signal and the data signal match each other; otherwise, providing a feedback signal, and re-providing the data signal until the check signal and the data signal match each other.

5. The data transmission method as claimed in claim 4, wherein the data signal is a binary code signal comprising binary bits, and the check signal is a representation of the sum of each binary bit of the binary code signal.

6. A data transmission method, comprising:
providing a data signal and a check signal in accordance with the data signal during a same time period;
comparing the check signal and the data signal; and
providing another data signal when the check signal and the data signal match each other; otherwise, providing a feedback signal, and re-providing the data signal until the check signal and the data signal match each other.

7. The data transmission method as claimed in claim 6, wherein the data signal is a binary code signal comprising binary bits, and the check signal is a representation of the sum of each binary bit of the binary code signal.
